(19) United States
(12) Patent Application Publication
(10) Pub. No.: US 2019/0254468 A1
(43) Pub. Date: Aug. 22, 2019

(54) Method and arrangement for producing personalized coffee

(71) Applicant: Gustav Paulig Ltd, Helsinki (FI)

(72) Inventor: Ville-Veikko VAARANMAA, Espoo (FI)

(73) Assignee: Gustav Paulig Ltd, Helsinki (FI)

(21) Appl. No.: 16/315,293

(22) PCT Filed: Jul. 7, 2017
(86) PCT No.: PCT/FI2017/050527

§ 371 Date: Jan. 4, 2019

(30) Foreign Application Priority Data
Jul. 8, 2016 (FI) 20165573

(51) Int. Cl. A47J 31/52; A23N 12/12; A47J 42/52; A23F 5/04; A23F 5/08; B65B 29/02; G06Q 30/06; G06Q 50/04

(52) U.S. Cl. CPC A47J 31/521; A23N 12/125; A47J 42/52; G06Q 50/04; A23F 5/08; B65B 29/02; G06Q 30/0621; A23F 5/04

(57) ABSTRACT

An arrangement for producing personalized coffee comprises a data gathering device for gathering user related data for producing said personalized coffee. The arrangement also comprises plurality a roasting systems, where each of the roasting system comprises hoppers with a selection of coffee bean varieties, a roasting unit for roasting the selected coffee bean varieties, a grinding unit for grinding the roasted coffee bean varieties, and a packaging unit for packaging the roasted and/or grinded coffee bean varieties. Further the arrangement comprises a controlling computer for receiving said user related data for producing said personalized coffee. The controlling computer is configured to form controlling parameters based on said user related data and thereby control the operations of at least one roasting device of said selected roasting system of said at least two roasting systems by said controlling parameters in order to produce said personalized coffee.

### TECHNICAL FIELD OF THE INVENTION

The invention relates to a method and arrangement for producing personalized coffee. The invention can also be applied for producing other types of foodstuff.

### BACKGROUND OF THE INVENTION

There are some solutions for providing consumer with a possibility to be involved in the process of creating a product known from prior art. These solutions are usually targeted for more durable goods, such as cars, accessories or shoes. These solutions are services which are not directly linked to the actual production process.

There are however some disadvantages relating to the known prior art, such as if the end product should be available to the consumer fast. Fast-moving consumer goods, such as coffee or other foodstuff products, are usually sold quickly at a relatively low cost but in high volumes, which makes it difficult to offer every customer a product to their specific taste. Consumer's willingness to pay of a product is also challenging to define, which makes it risky to bring niche-products to the market, especially with high volume products. In addition one drawback relates to offering the specially tailored product, such as personalized coffee or other foodstuff products for example, to the customers fast and in addition globally in a same manner with same quality and properties independently of the amount of the product.

### SUMMARY OF THE INVENTION

An object of the invention is to alleviate and eliminate the problems relating to the known prior art. Especially the object of the invention is to provide a method and arrangement for producing personalized coffee or other foodstuff so that consumer can freely decide the level of customization of fast-moving consumer good (FMCG) and tailor-make most individualist product, such as coffee for her/himself. In addition an object is to enable fast offering of the product globally and essentially in a same manner with same quality and properties independently on the location or of the amount of the product. Moreover an object is to determine or explore customers' behaviour and changes in trends.

The object of the invention can be achieved by the features of independent claims.

The invention relates to an arrangement for producing personalized coffee according to claim 1. In addition the invention relates to a method for producing personalized coffee according to claim 13.

According to an embodiment of the invention an arrangement for producing personalized coffee comprises a data gathering device for gathering user related data for producing personalized coffee. In addition the arrangement comprises a number of roasting systems, where each of the roasting system comprises hoppers with a selection of coffee bean varieties, a roasting unit for roasting the selected coffee bean varieties, a grinding unit for grinding the roasted coffee bean varieties, and a packaging unit for packaging the roasted and/or grinded coffee bean varieties. Further the arrangement comprises a controlling computer for receiving said user related data for producing personalized coffee. The controlling computer is advantageously configured to form controlling parameters based on said user related data and thereby control the operations of at least one roasting device by said controlling parameters in order to produce said personalized coffee.

As an example each of the roasting systems may comprise own roasting system controlling computer for receiving said user related data either directly or from a central server, such as from a cloud-based controlling computer, and for forming said controlling parameters, or alternatively the arrangement may comprise centralized controlling computer system for receiving said user related data and for forming said controlling parameters for example for a certain roasting system. The centralized controlling computer system may be implemented e.g. by a cloud-based server, which is hereafter discussed as an example, but naturally the centralized controlling computer can also be implemented by another type centralized controlling computer.

According to an embodiment of the invention the arrangement, as well as the method, for producing personalized coffee comprises a roasting system configured to create a personalized product based on production parameters set by user data gathered from application software advantageously through the cloud-based server. The data gathered from the application software can also be stored on the cloud-based server and accessed by a marketing entity also connected to the said server.

The application software can be utilized with a mobile device e.g. a smart phone, a computer or a tablet computer. The roasting system comprises hoppers with a selection of coffee bean varieties, a roasting unit, a grinding unit and a packaging unit. In addition the system comprises or is in a data communication with a controlling computer for controlling the operations of the roasting system. The user can advantageously create a personal recipe for the product with the application software by choosing a desired combination of production parameters or tuning an existing recipe. The recipe advantageously comprises components of the product to be produced (such as selection of beans) but also a manufacturing method, packaging methods and parameters of a roasting curve as an example, but can naturally include also other information. The user data from the application software is transferred through the cloud-based server to the controlling computer for controlling the roasting system, and thereby starting the production cycle. According to an example the controlling parameters for controlling the operation of a certain roasting system is advantageously formed in the cloud-based server. In addition the data may comprise also identifying data identifying a certain roasting system from a group of different roasting systems, for example identifying that the user would like to have the personal roasted coffee in a certain super store.

The marketing entity can also access the user data from the cloud-based server and process it, for example, software can create detailed consumer segmentation for marketing purposes from the information infeed of single consumer's entity. Data enriches the accuracy when more similar entities will be entered to the system. Also the software will formulate history data for all parameters to predict the future and see how history has evolved. Also all data can be collected from paying customer from the individual recipe entered in to the software, so the presumption is that it is more accurate and true than bought marketing information.

The processed data from the marketing entity can also be made available to the end user through the application software.

In addition, according to an embodiment the user related data may comprise also genetic information of the user or a reference to a user genetic information. In the embodiment the controlling computer, advantageously the cloud-based controlling computer may have an access to a genetic information databank, where the databank comprises correlations with genetic information, effects (or probabilities of effects) of coffee components with certain genes (e.g. when active), whereupon the controlling computer is configured to form said controlling parameters by taking into account said genetic information and effects of coffee components with certain genes so that undesired effects can be avoided by minimizing or omitting certain components or coffee variety having said components. Thus for example if the user has a certain gene, which causes sickness or some unwanted effect with a certain component, said coffee variety with said component is then avoided and the controlling computer is configured to form said controlling parameters so to avoid or minimizing said component or coffee variety having said component.

The present invention offers advantages over the known prior art, such as possibility to bring the user as a skier or driver of the production process and create consumer tailored coffee or other foodstuff products. With the user data obtained from the application software, the invention also offers a possibility for custom production of coffee or other foodstuff for a specific consumer or customer group in a small or large scale (hereinafter consumer). In addition the user can use his personalized data stored in the cloud-based server everywhere independently of the location. For example the user can tailor the recipe for a small amount of personalized product, such as for 500 g coffee, which is to be produced in a local convenience store, but the same recipe can be used for producing the same product also in other store having suitable arrangement for producing said personalized product and being in a data communication with the cloud-based server storing the recipe data. As an example the amount of the manufactured product can be scaled and for example the said recipe for 500 g of coffee can be up-scaled for example for 500 kg (or even more) of coffee to be manufactured in an industry scale roastery and to be delivered and offered in a public consumer market.

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates a principle of an exemplary arrangement for producing personalized coffee according to an advantageous embodiment of the invention, and

FIG. 2 illustrates another exemplary arrangement for producing personalized coffee according to an advantageous embodiment of the invention.

### DETAILED DESCRIPTION

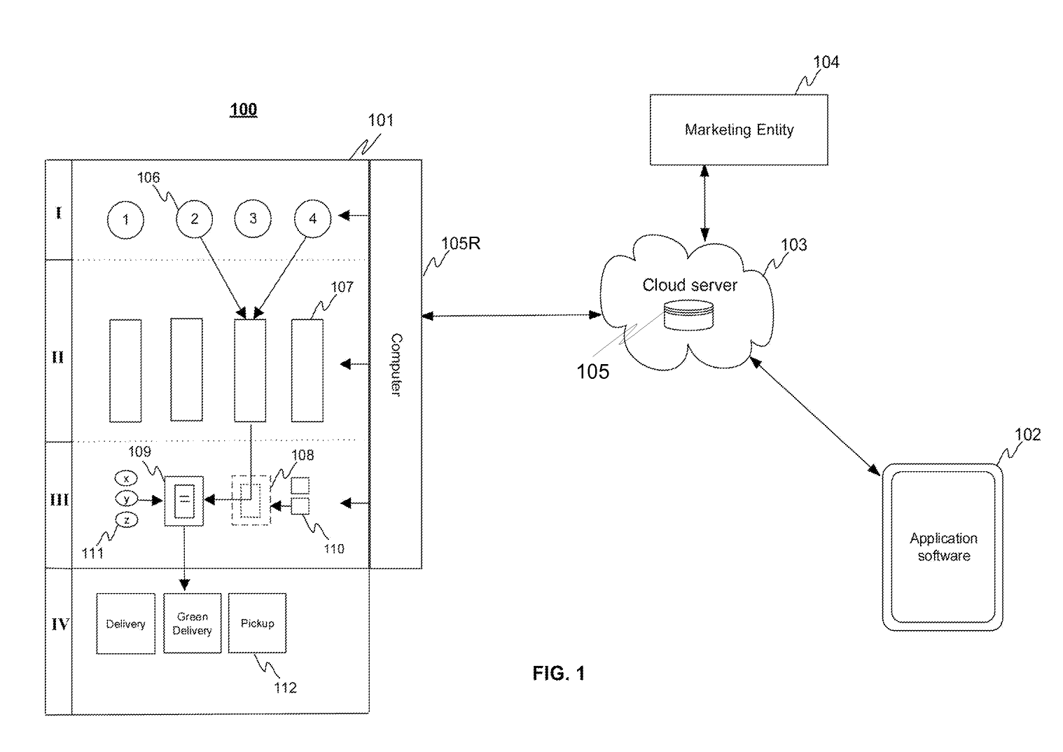

FIG. 1 illustrates a principle of an exemplary arrangement 100 for producing personalized coffee. The arrangement comprises a roasting system 101 at least partially controlled by application software 102 through a cloud-based server 103 (implemented advantageously by a cloud-based controlling computer 105). Advantageously the arrangement also comprises a marketing entity 104 connected to the cloud-based server 103. The user data from the application software 102 can be transferred and stored in the cloud-based server 103 and accessed by the marketing entity 104.

The roasting system 101 comprises or is at least in a data communication with a roasting system controller computer 105R. The roasting system 101 comprises also an arrangement to produce a personalized product based on the user data. The roasting system advantageously comprises at least one of the following steps: selection of bean varieties and roast size (I), determining a roast curve and roasting process (II), grinding process and/or packaging process (III), and setting a delivery method (IV).

Step I comprises at least two hoppers 106, each containing a different variety of coffee beans. The user may select one or combine two or more of the said varieties to the product and select the size of the roast. The selected amount of beans is directed to a roasting unit 107.

Step II comprises the roasting unit 107 and a selection of a degree of roast by determining a roast curve. The roast curve is presented as a temperature-time function. The user can determine a specific roast curve or alternatively select the desired degree of roast, which then sets the roast curve accordingly. From the roasting unit 107 the roasted beans are directed either to a grinding unit 108 or straight to a packaging unit 109.

Step III comprises the grinding unit 108 and the packaging unit 109. In the grinding unit 108 the user can choose from different grind levels 110. In case no grind is desired, the product simply passes through the grinding unit 108 to the packaging unit 109. The packaging unit 109 includes at least three alternative options 111 for the packaging type, e.g. pack format, print and sealing. The packaged product is directed to delivery.

Step IV comprises a selection of delivery methods 112, e.g. traditional delivery, green delivery or pickup. The method is set by the user.

The user data which controls or is used to control the production process is obtained from the application software 102 advantageously through the server 103. Once the user has set the production parameters for the personalized product, the recipe can be stored on the server 103 and reused later.

The marketing entity 104, which also can have access to the user data from the database on the server 103, can suggest a recipe for further development and feasibility study.

The processed data from the marketing entity 104, e.g. an advertisement for a product targeted to a consumer group that fits the user's consumer profile, can be made available to the user through the application software 102.

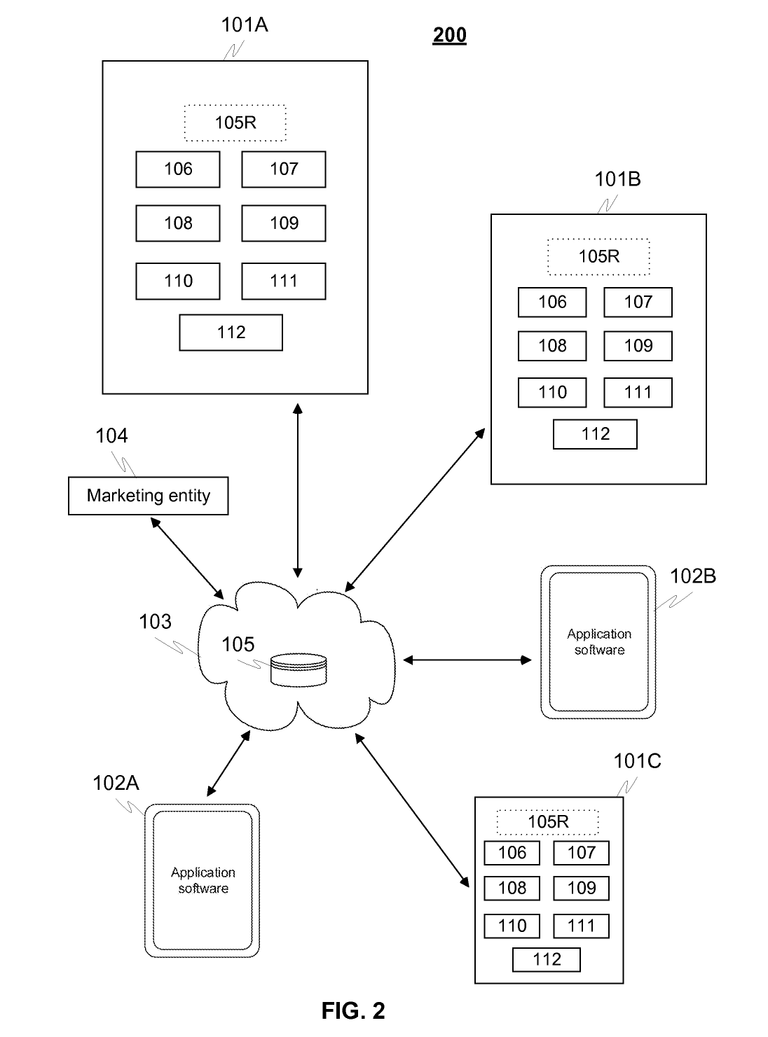

FIG. 2 illustrates another exemplary arrangement 200 for producing personalized roasted coffee from coffee beans according to an advantageous embodiment of the invention, where the arrangement comprises number or roasting systems 101A-101C located typically in different places. One of the roasting systems may be a local store roasting system 101A, second a super market roasting system 101B and third as a big industrial roaster 101C. According to an embodiment all of these roasting systems comprise roasting devices 106-109 as depicted and discussed elsewhere in this document, for example in connection with FIG. 1.

In addition there are number of data gathering devices 102A-102B for gathering user related data from different users and delivering said data to a cloud-based 103 controlling computer 105 for producing personalized coffee by a selected roasting system of said roasting systems 101A-101C. The user can select the parameters in relation to the product to be produced, but also advantageously select and identify the roasting system 101A-101C he would like to use from the group of different roasting systems.

The data gathering devices 102A-102B are in a data communication with the could-based 103 controlling computer 105, which receives the user related data. According to an embodiment the could-based 103 controlling computer 105 may identify the selected roasting system 101A-101C, manage the user related data for example for statistical or marketing purposes, for example, and deliver at least portion of said user related data to the selected roasting system 101A-101C and especially to the roasting system controlling computer 105R, which then forms controlling parameters based on said user related data in order to control the selected roasting system 101A-101C in question to produce said personalized roasted coffee.

According to embodiment the could-based 103 controlling computer 105 may also form the controlling parameters to the selected roasting system 101A-101C in question based on said user related data and transfer said formed controlling parameters to the selected roasting system 101A-101C in question. After receiving said formed controlling parameters by the selected roasting system 101A-101C, the controlling parameters are then run advantageously on the roasting system controlling computer 105R, which is configured to control the selected roasting system 101A-101C in question based on said controlling parameters to produce said personalized roasted coffee.

However, according to an embodiment the roasting system controlling computer 105R at the roasting system 101 for forming said controlling parameters may be optional and the producing process can be also controlled by the cloud based controlling computer 105.

According to the invention anybody can register to the system and create own recipe. It is to be noted that the recipes formed by the individuals or the factories and stored on the cloud based system 103, 105 may be public, whereupon anybody can use the recipe as such or take it as a base and tailor further recipes. In addition it is to be noted that the different roasting systems 101A-101C may locate different locations and be different sizes and from small local store 101A to super store 101B and additionally to industrial size roaster factories 101C, which all of them can be controlled by same way, so using data gathering devices 102A, 102B and centralized cloud-based controlling computer 105.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims. For example the concept of the present invention can also be applied for producing other types of foodstuff than described here in details. In addition it is to be noted that according to the embodiment of the invention it is also possible to collect consumer insights data and use said data directly on a laboratory R&D roasting machine e.g. for testing purposes, but also for bigger roaster systems, such as even an industrial size roaster factories. By the embodiment of the invention the small local store as well as the super store roaster systems and the laboratory R&D roasting machines can be equipped with same production automatization software as big industrial scale roaster. Naturally the number of different parameters to be adjusted by the smaller size roasting environment can be smaller than in the big industrial scale roasters, but the idea is at least the basic parameters are the same, and additionally the individual product can be directly converted and up-scaled to big scale production.

The features recited in dependent claims are mutually freely combinable unless otherwise explicitly stated.

1. An arrangement for producing personalized roasted coffee from coffee beans,
wherein the arrangement comprises:
at least one roasting system, the roasting system comprising roasting devices of:
hoppers with a selection of coffee bean varieties,
a roasting unit for roasting the selected coffee bean varieties, or
a packaging unit for packaging the roasted or grinded coffee bean varieties,
a data gathering device for gathering user related data and delivering said data to a controlling computer for producing personalized coffee by a roasting system, and
said controlling computer is configured for receiving said user related data for producing personalized roasted coffee, and to form controlling parameters based on said user related data, wherein said arrangement is configured to control the operations of at least one roasting device of said roasting system by said controlling parameters provided by said controlling computer in order to produce said personalized coffee.

2. The arrangement of claim 1, wherein the arrangement comprises a roasting system controlling computer and a cloud-based controlling computer which is in a data communication with the roasting system controlling computer, and where the cloud-based controlling computer provides the controlling parameters to be used for producing said personalized coffee to the roasting system controlling computer based on said user related data.

3. The arrangement of claim 1, wherein the roasting system comprises a roasting system controlling computer, which is configured to receive said user related data and to form said controlling parameters or receive said controlling parameters from a cloud-based controlling computer, and is configured to use said controlling parameters to produce said personalized coffee.

4. The arrangement of claim 1, wherein arrangement comprises at least two roasting systems, and wherein:
said data gathering device is configured for gathering user related data and identify one roasting system from the group of at least said two roasting systems and delivering said data to the controlling computer for producing personalized coffee by the selected roasting system, and
said controlling computer is configured for receiving said user related data for producing personalized roasted coffee, and to form controlling parameters based on said user related data, wherein said arrangement is configured to control the operations of at least one roasting device of said selected roasting system of said at least two roasting systems by said controlling parameters provided by said controlling computer in order to produce said personalized coffee.

5. The arrangement of claim 1, wherein the roasting systems additionally comprises also a grinding unit for grinding the roasted coffee bean varieties.

6. The arrangement of claim 1, wherein said user related data comprises indication of at least one of the following:
selection of bean varieties,
roast size,
a roast curve,
grinding level,
packaging type and a delivery method, or
identifying data of the selected roasting system of said at least two roasting systems.

7. The arrangement of claim 1, wherein the roasting system is configured to:
select bean varieties and amount of each beans,
set roast size,
set a roast curve parameters,
set a degree of a grinding level or
select packaging type and indicate a delivery method, under the controlling of said controlling computer and said controlling parameters.

8. The arrangement of claim 1, wherein the data gathering device is a mobile device, such as a smart phone, a computer or a tablet computer, and wherein said data gathering device is in a data communication with a controlling computer, a cloud-based controlling computer or with the roasting system controlling computer, to transfer said user related data.

9. The arrangement of claim 1, wherein the roasting system controlling computer is in a data communication with a cloud-based controlling computer to receive said user related data and thereby forming said controlling parameters based on said received user related data.

10. The arrangement of claim 1, wherein the controlling computer is configured to take into account genetic information of the user or a reference to a user genetic information, and whereupon the controlling computer is configured to form said controlling parameters by taking into account said genetic information and effects of coffee component with certain genes so that certain components are avoided or favoured by minimizing or omitting or maximizing said components or coffee variety having said component.

11. The arrangement of claim 1, wherein the packaging unit is configured to package roasted or grinded coffee bean varieties into a package type indicated by the user related data and controlling parameters by said controlling computer.

12. The arrangement of claim 11, wherein said package type to be selected comprises at least a pack format, print and sealing.

13. A method for producing personalized roasted coffee from coffee beans by a roasting system,
wherein the method comprises:
gathering user related data by a data gathering device and delivering said data to a controlling computer for producing personalized coffee by the roasting system, and
receiving said user related data and forming controlling parameters based on said user related data by said controlling computer to control the operations of the one roasting device of said roasting system by said controlling parameters in order to produce said personalized roasted coffee, wherein said operations of at least one roasting device comprises:
selecting coffee bean varieties from hoppers,
roasting the selected coffee bean varieties, or
packaging the roasted coffee bean varieties.

14. The method of any claim 13, wherein the method is for producing personalized roasted coffee from coffee beans by a selected roasting system of at least two roasting systems, wherein the method comprises steps of:
gathering user related data by said data gathering device and delivering said data to said controlling computer for producing personalized coffee by a selected roasting system of said at least two roasting systems, and
receiving said user related data and forming controlling parameters based on said user related data by said controlling computer to control the operations of the one roasting device of said selected roasting system of said at least two roasting systems by said controlling parameters in order to produce said personalized roasted coffee.

15. The method of claim 13, wherein said operations of at least one roasting device comprises also grinding the roasted coffee bean varieties.

16. The method of claim 13, wherein said user related data comprises indication of at least one of the following:
selection of bean varieties,
roast size,
a roast curve,
grinding level,
packaging type and a delivery method, or
identifying data of the selected roasting system of said at least two roasting systems.

17. The method of claim 13, wherein the method comprises:
select bean varieties and amount of each beans,
set roast size,
set a roast curve parameters,
set a degree of a grinding level or
select packaging type and indicate a delivery method,
under the controlling of said controlling computer and said controlling parameters.
